(19) United States
(12) Patent Application Publication
(10) Pub. No.: US 2026/0336999 A1
(43) Pub. Date: Oct. 29, 2026

(54) Eye Drop Bottle Opening Assistive Apparatus

(71) Applicant: Edward Stull, Columbus, OH (US)

(72) Inventor: Edward Stull, Columbus, OH (US)

(21) Appl. No.: 19/651,763

(22) Filed: Apr. 19, 2026

Related U.S. Application Data
(60) Provisional application No. 63/793,818, filed on Apr. 24, 2025.

(51) Int. Cl. B67B 7/18

(52) U.S. Cl. CPC B67B 7/18

(57) ABSTRACT

An apparatus for opening an eye drop bottle includes a grip handle and a cap-turning wrench. The grip handle has a main body defining an internal cavity dimensioned to receive a squeezable bottle body, a wall surrounding the cavity having an axially extending slot that permits radial flex of wall sections adjacent to the slot, and an external grasping surface larger in area than the bottle body. The wrench includes a housing, a jaw assembly with two opposing jaws defining a receiving area for the cap, and a compliance mechanism comprising an arch structure connecting the jaws and biasing them inward. Inner surfaces of the jaws are textured and tapered such that a distance between the inner surfaces is greater at a distal entry end than at a proximal base end. In use, the handle retains the bottle body while the wrench applies rotational torque to the cap.

### CROSS-REFERENCE TO RELATED APPLICATIONS

This application claims priority to U.S. Provisional Application No. 63/793,818, filed Apr. 24, 2025, the entire contents of which are hereby incorporated by reference.

### STATEMENT REGARDING FEDERALLY SPONSORED RESEARCH OR DEVELOPMENT

Not Applicable.

### BACKGROUND OF THE INVENTION

### Field of the Invention

The present invention relates generally to assistive medical devices and tools, and more specifically to a cooperative two-part apparatus comprising a cooperating handle and wrench designed to assist users in opening small, squeezable medical fluid containers. The apparatus is specifically configured to decouple the stabilization of the flexible bottle body from the rotational torque required to actuate the cap, thereby preventing bottle deformation and rotational “spinning” failures common in single-component assistive devices.

### Description of the Related Art

The administration of medicated eye drops is a daily requirement for millions of people managing conditions such as glaucoma, dry eye syndrome, and post-surgical recovery. However, many individuals, particularly seniors and those with limited hand strength or dexterity, experience difficulty opening standard-sized eye drop bottles. The physical design of these bottles inherently requires a user to simultaneously execute two oppositional forces: a tight pinch-grip to stabilize the small, squeezable bottle body, and a high-torque twisting motion to break the factory seal or overcome the friction of a tightly secured cap.

The small size, tight caps, and the need to grip and twist often present a significant challenge. For individuals suffering from arthritis, neuropathy, tremors, or general loss of muscle mass, these concurrent fine-motor requirements are often insurmountable. This inability to independently access necessary medication can lead to severe consequences, including frustration, medication non-compliance, and reliance on others for assistance.

The clinical significance of this problem is well-documented in the peer-reviewed medical literature and has persisted without an adequate solution for more than three decades. Published studies have established that a substantial proportion of ophthalmic patients—estimated at up to fifty percent—experience measurable physical difficulty managing their eye drop delivery devices, with arthritic patients and the elderly disproportionately affected. Peer-reviewed investigations have demonstrated that patients suffering from arthritis frequently cannot generate sufficient grip force to operate a standard eye drop bottle, and that these same patients experience compounding difficulty with the additional fine-motor movements required for drop administration. The physical barrier to bottle access has been directly correlated in published studies with medication non-compliance, which in the context of conditions such as glaucoma can lead to irreversible disease progression and preventable vision loss requiring invasive surgical intervention.

The severity of this problem has been acknowledged at the regulatory level. The United States Food and Drug Administration has received and acted upon consumer complaints documenting that ophthalmic bottle caps are frequently secured with excessive torque, and has directed manufacturers to revise torque specifications to enable easier cap removal. The FDA has specifically recognized that ophthalmic product bottles are significantly smaller than standard beverage containers and that the limited surface area available for gripping and manipulating the bottle and cap amplifies the difficulty of opening, particularly for elderly patients or patients with reduced dexterity. Despite this regulatory recognition, the FDA's remedial approach was limited to requesting that manufacturers reduce cap torque—a solution that addresses only one variable in a multi-variable problem and does not assist the millions of patients who must contend with bottles already in circulation or who lack the hand strength to open even a reduced-torque cap.

Critically, this long-felt need has persisted despite active innovation in the adjacent field of eye drop administration aids. A substantial body of prior art has developed around assistive devices for the dispensing and instillation of eye drops—devices designed to address aiming, eyelid retraction, bottle positioning relative to the eye, and force amplification for squeezing. However, these dispensing-focused devices uniformly presuppose that the bottle has already been opened. No prior art device known to the applicant addresses the antecedent mechanical challenge of removing the cap from a small, squeezable medical fluid container in the first instance. The persistent, decades-long gap between the well-documented need and the absence of any targeted solution is itself objective evidence that the present invention was not obvious to persons of ordinary skill in the art.

Unlike rigid jars or cans, eye drop bottles present a unique ‘squeezability’ constraint where applying the torque required to break a factory seal often results in the unintended deformation of the bottle body, leading to a loss of grip. Prior art single-component tools fail to address this because they do not decouple the stabilization of the flexible body from the rotation of the cap.

While various general-purpose assistive opening devices exist in the prior art, they suffer from notable shortcomings when applied to the specific form factor of eye drop bottles:
Flexible Rubber Grip Pads: These commonly used items provide enhanced surface friction but do not mechanically reduce the amount of pinch-grip strength or rotational torque the user must generate. They still require the user to possess sufficient hand strength to pinch the tiny cap and twist.
Standard Pliers or Wrenches: General mechanical tools can apply torque, but they lack compliance mechanisms suitable for thin-walled medical bottles. Consequently, they easily over-compress, resulting in the crushing or cracking of the delicate plastic cap or the bottle body, which can contaminate the sterile tip or spill the medication.
Single-Component Openers and General-Purpose Cap Tools: Many existing assistive devices in the general bottle-opening art focus exclusively on engaging the cap while failing to provide adequate stabilization for the bottle body. These devices are overwhelmingly designed for and calibrated to rigid containers—glass jars, beverage bottles, and similar vessels whose bodies maintain structural integrity under grip pressure. This design assumption is fundamentally incompatible with the physical characteristics of squeezable eye drop bottles. A person of ordinary skill in the assistive device art, examining a cam-based cap opener or strap-wrench jar tool, would recognize that these devices rely on the implicit premise that the container body does not deform under the counter-torque forces generated during cap removal. Applying such a device to a thin-walled, squeezable polyethylene eye drop bottle of 5 mL to 15 mL volume would predictably result in bottle deformation, loss of grip, and potential medication contamination—the very failure modes the devices are designed to prevent in their intended rigid-container applications. The prior art in general-purpose openers therefore teaches toward rigid-container use and implicitly teaches away from application to squeezable medical fluid containers.

Furthermore, the subset of prior art that does address small medical containers is limited to single-component devices that attempt to simultaneously grip the cap and stabilize the bottle body within a single mechanism. These single-component approaches fail to decouple the stabilization of the flexible body from the rotation of the cap. Attempting to turn the cap with a single-component tool causes the small bottle body to spin freely in the user's opposite hand, because the user's weakened grip cannot independently resist the torque being applied. This “spinning” failure mode is a direct and predictable consequence of the single-component architecture and represents a fundamental design limitation rather than merely an incremental shortcoming.

The failure of any prior art device—whether general-purpose or medical-specific—to address the specific combination of constraints presented by squeezable eye drop bottles (small size, thin walls, deformable body, high cap torque relative to available grip strength, and the need for non-destructive engagement to preserve sterility) further demonstrates that the two-part decoupled architecture of the present invention represents a non-obvious departure from the established approaches in the art.

Therefore, there is a need for a simple, effective, and user-friendly apparatus that reduces the physical effort required to open these bottles. Specifically, there remains a distinct need in the art for an integrated, two-part system that simultaneously immobilizes the crushable bottle body and applies compliant, non-destructive rotational torque to the cap.

### SUMMARY OF THE INVENTION

The present invention is directed to a two-part assistive apparatus designed to facilitate the opening of standard-sized medical fluid containers, particularly eye drop bottles, by users with limited hand strength or dexterity. The apparatus achieves this by distinctly separating (decoupling) and mechanically assisting the two simultaneous actions required to open such bottles: immobilizing the squeezable bottle body and applying rotational torque to the cap. The present invention provides a coordinated two-part architecture that isolates rotational torque to the cap assembly while providing a dedicated mechanical anchor for the bottle body, thereby preventing the ‘spinning’ failure mode common in single-component assistive devices.

To achieve these objectives, the apparatus comprises two primary cooperating components: a bottle-stabilizing grip handle and a cap-turning wrench.

The bottle-stabilizing grip handle is configured to securely hold the bottle body without crushing it. The handle comprises a main body defining an internal cavity that substantially conforms to the geometry of standard eye drop bottles (e.g., accommodating volumes from approximately 5 mL to 15 mL). The wall defining this internal cavity features an axially extending slot that permits radial flex, facilitating easy insertion and removal of the bottle. The internal cavity further employs a high-friction material, such as thermoplastic polyurethane of a specific Shore A hardness, to prevent the bottle from slipping. The exterior of the grip handle provides a significantly enlarged, ergonomically contoured grasping surface, allowing the user to easily resist the rotational forces applied during opening.

The cap-turning wrench is configured to comfortably and securely engage the bottle cap. The wrench comprises a user-manipulable housing and a jaw assembly with two opposing jaws. A compliance mechanism, preferably an arch structure connecting the jaws, biases the jaws inward. Upon insertion of the cap, the compliance mechanism deforms slightly, causing the jaws to exert a compliant, non-destructive gripping force. The inner surfaces of the jaws are textured and tapered—being wider at a distal entry end and narrower at a proximal base end—creating a wedging effect that significantly enhances the grip on the cap as the wrench is seated.

In operation, the user places the bottle body into the grip handle to immobilize it, seats the cap-turning wrench over the cap to securely engage it via the compliance mechanism, and applies rotational torque to the wrench. The complete apparatus thereby translates gross motor movements of the hands and wrists into the fine-motor torque required to open the bottle, without risking damage to the container or its contents. Furthermore, alternative embodiments of the invention may include a connection mechanism for releasably coupling the handle and wrench for convenient, nested storage.

A significant and non-obvious aspect of the present invention resides in the functional interdependence between the two cooperating components. The compliance mechanism of the cap-turning wrench is specifically calibrated to exert a gripping force that is sufficient to engage the cap but insufficient to crush or crack the delicate plastic cap or compromise the sterile tip—a calibration that is achievable only because the bottle-stabilizing grip handle independently and simultaneously prevents the bottle body from rotating. In the absence of the grip handle, a cap-engaging wrench operating on a squeezable eye drop bottle would need to exert substantially greater gripping force to compensate for the tendency of the unsecured bottle body to spin under torque, and this increased force would predictably exceed the crush threshold of the cap. Conversely, in the absence of the wrench, the grip handle alone provides no mechanism for applying the rotational torque needed to overcome factory-seal resistance. Neither component, when used individually in conjunction with a user's bare hand as the counterpart, achieves the result produced by the cooperating pair. The two-part architecture therefore produces a cooperative result that is not produced by either component operating individually: specifically, it enables a controlled, non-destructive compliance calibration for the wrench that would be mechanically infeasible in any single-component device or any configuration in which the bottle body is not independently immobilized.

### BRIEF DESCRIPTION OF THE DRAWINGS

The accompanying drawings, which are incorporated in and constitute a part of this specification, illustrate presently preferred embodiments of the invention and, together with the description, serve to explain the principles of the invention.

FIG. 1 is a front elevation view of the cap-turning wrench component of the assistive apparatus, illustrating the housing, the compliance mechanism, and the jaw assembly in an open configuration.

FIG. 2 is a top plan view of the cap-turning wrench component, illustrating the tapered inner surfaces of the jaw assembly.

FIG. 3 is a perspective view of the cap-turning wrench component, detailing the tapered inner surfaces of the jaws.

FIG. 4 is a top plan view of the bottle-stabilizing grip handle component, showing the main body, the internal bottle-receiving cavity, and the external ergonomic grasping surface.

FIG. 5 is a perspective view of the bottle-stabilizing grip handle component, demonstrating the chamfered edge of the internal cavity and the contoured external grasping surface.

FIG. 6 illustrates the assistive apparatus in an initial stage of operation, showing the grip handle being aligned to receive an eye drop bottle.

FIG. 7 illustrates the assistive apparatus in operation, showing the grip handle actively stabilizing the body of the eye drop bottle.

FIG. 8 illustrates the assistive apparatus in operation, showing the cap-turning wrench positioned prior to engagement with the cap of the stabilized eye drop bottle.

FIG. 9 illustrates the assistive apparatus in full operation, showing the cap-turning wrench engaging and rotating the eye drop bottle's cap relative to the stabilized bottle body.

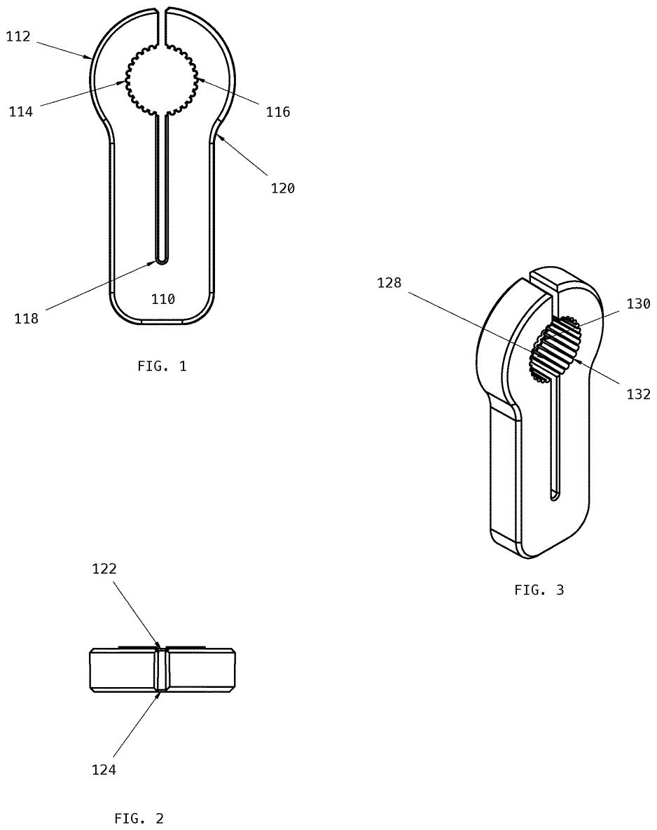

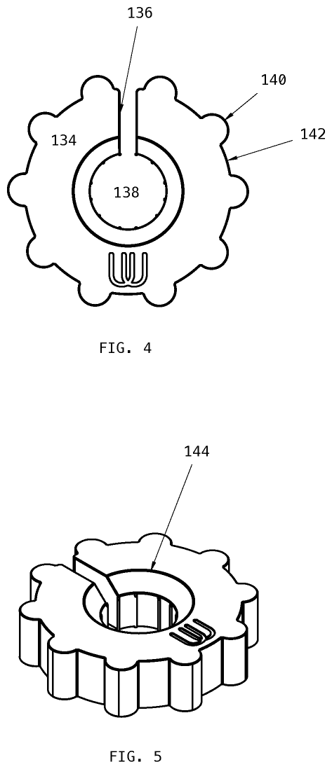

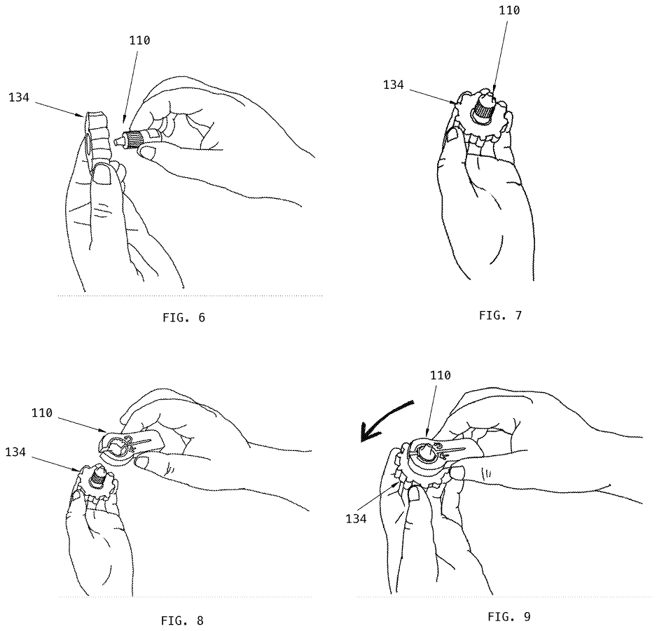

### DETAILED DESCRIPTION OF THE PREFERRED EMBODIMENTS

Reference will now be made in detail to the presently preferred embodiments of the invention, examples of which are illustrated in the accompanying drawings. Wherever possible, the same reference numbers will be used throughout the drawings to refer to the same or like parts.

### I. Overview

The present invention is a two-part assistive apparatus designed to facilitate the opening of standard-sized eye drop bottles. The apparatus comprises two primary cooperating components: a cap-turning wrench 110 and a bottle-stabilizing grip handle 134. The present invention provides a coordinated two-part architecture that isolates rotational torque to the cap assembly while providing a dedicated mechanical anchor for the bottle body, thereby preventing the ‘spinning’ failure mode common in single-component assistive devices.

### II. The Cap-Turning Wrench

In an exemplary embodiment, the cap-turning wrench 110 generally comprises a housing 112, a jaw assembly comprising two opposing jaws 114 and 116, and a compliance mechanism 118.
Housing: The housing 112 forms the primary structural body of the wrench 110 and serves as the interface for the user to hold and manipulate the device. The external surface of the housing 112 incorporates ergonomic features, such as contoured surfaces and grip areas 120, designed to enhance user comfort and provide a secure, non-slip grip during the application of rotational force.
Jaw Assembly: The jaw assembly is operatively integrated within the housing 112. The jaws 114 and 116 define a receiving area adapted to encompass the exterior of a bottle cap. These jaws are movable relative to the housing between an open configuration, allowing the wrench to be placed over a cap, and a closed configuration, wherein the jaws 114 and 116 securely engage the cap.
Compliance Mechanism: The compliance mechanism 118 comprises an arch that divides the housing and separates the two opposing jaws 114 and 116. This mechanism biases the jaws inward, allowing for a degree of resilient conformance of the jaws 114 and 116 to the cap's surface. The compliance mechanism 118 is specifically designed to the material properties of thin-walled medical fluid containers. Unlike the rigid jaws of general-purpose pliers or kitchen tools which risk crushing or cracking delicate plastic caps, the arch structure of the present invention provides a tuned deformation profile that converts downward pressure into a gentle, distributed inward gripping force.

The calibration of the compliance mechanism 118 is specifically enabled by the cooperative presence of the bottle-stabilizing grip handle 134 within the two-part system. In a standalone cap-engaging tool—or in any configuration where the bottle body is not independently immobilized—the compliance mechanism would need to be calibrated to a substantially higher gripping force to prevent the cap from slipping under the combined load of rotational torque and the reactive spinning tendency of an unsecured bottle body. Such elevated gripping forces would predictably exceed the structural limits of thin-walled medical bottle caps, resulting in cap crushing, cracking, or deformation of the sterile dispensing tip. The present invention overcomes this constraint by architecturally separating the torque-resistance function (assigned to the grip handle 134) from the torque-application function (assigned to the wrench 110), thereby permitting the compliance mechanism 118 to be tuned to a force threshold that is calibrated solely against the frictional resistance of the cap threads rather than against the combined resistance of cap threads plus bottle-body rotation. This decoupled calibration represents a mechanical configuration that is not provided by any single-component assistive device and is not suggested by the prior art in general-purpose bottle or jar openers, which uniformly assume a rigid, non-deformable container body.
Taper and Texturing: The inner, cap-contacting surfaces 128 of the jaws 114 and 116 provide knurling to enhance grip and minimize slippage. Additionally, these inner surfaces 128 are configured with a slight draft angle or taper along their height. Specifically, the distance between the opposing inner surfaces 128 is slightly greater at a distal or entry end 132 and 124 compared to a proximal or base end 130 and 122. As the wrench is fully seated onto the cap, the progressively narrowing gap towards the proximal end 130 creates a wedging effect, which significantly enhances the gripping force exerted by the textured features.

In preferred embodiments, each of the inner surfaces 128 defines a concave profile having a radius of curvature of between approximately 7 mm and approximately 10 mm in a transverse cross-section, the concave profile being shaped to conform to the outer surface of a standard ophthalmic bottle cap. In further preferred embodiments, the arch structure of the compliance mechanism 118 defines an inner radius of between approximately 8 mm and approximately 12 mm in an unflexed state.

In preferred embodiments, the inner surfaces 128 define a draft angle of between approximately 0.5° and approximately 8° relative to a longitudinal axis of the wrench 110, with a draft angle of between approximately 0.5° and approximately 3° being particularly preferred for engagement with standard ophthalmic bottle caps.

In a particularly preferred embodiment, the cap-turning wrench 110 has a maximum overall length along its longitudinal axis of between approximately 70 mm and approximately 90 mm and a maximum overall width transverse to the longitudinal axis of between approximately 30 mm and approximately 45 mm.

### III. the Bottle-Stabilizing Grip Handle

The main body of the handle 134 defines an internal cavity 138 shaped to receive the bottle body. Along one side of the main body, an axially extending slot 136 passes through the wall from the external surface to the internal cavity 138.
Internal Cavity: This cavity 138 is dimensioned and shaped to conform substantially to the external geometry of the target eye drop bottle body. To accommodate standard variations in the industry, the internal cavity 138 is dimensioned to receive standard eye drop bottle volumes ranging from approximately 5 mL to 15 mL.
Flexibility Slot: The wall defining the internal cavity 138 features a discontinuity in the form of an axially extending slot 136. This slot extends through the height of the cavity wall, allowing the wall sections adjacent to the slot to flex radially, which facilitates the insertion and removal of the eye drop bottle. Furthermore, a chamfer around the edge 144 of the cavity provides additional access to extract the bottle once opened.

The axially extending slot 136 is not merely for ease of insertion; it serves as a dynamic tensioning element. By allowing radial flex, the slot enables the internal cavity 138 to adapt to minor variations in bottle diameter while maintaining a continuous friction engagement. This specifically overcomes the known failure mode in the art where a squeezable bottle body spins freely within a user's hand or a rigid stabilizer during the application of high torque.

The dynamic tensioning function of the axially extending slot 136 cooperates with the compliance mechanism 118 of the cap-turning wrench 110 in a manner that produces a result not achievable by either feature independently. Because the slot 136 enables the internal cavity 138 to maintain a friction-fit engagement across minor variations in bottle diameter, the bottle body remains rotationally locked within the handle 134 even as the wrench 110 applies torque to the cap. This rotational locking, in turn, ensures that the reactive torque experienced by the compliance mechanism 118 is limited to the frictional resistance of the cap threads and does not include any additional rotational load from a spinning bottle body. The dynamic tensioning therefore functionally enables the gentle compliance calibration of the wrench 110 described above, establishing a cooperative mechanical relationship between the slot 136 of the handle 134 and the arch structure of the compliance mechanism 118 that spans both components of the apparatus and that is not suggested by any single element of the prior art considered in isolation.
Ergonomic Grasping Surface: The external surface of the main body 134 is configured to serve as a grasping interface 140 that provides a significantly larger surface area compared to the diameter of the eye drop bottle body itself. The grasping surface 140 is ergonomically contoured to comfortably accommodate the user's palm and fingers, incorporating finger indentations 142 designed to promote a secure and stable grip.

### IV. Materials, Manufacturing, and Additional Features

The internal surface of the cavity 138 features texturing and employs a material with a high coefficient of friction, such as thermoplastic polyurethane (TPU), to further enhance the grip on a bottle body. To optimize grip without crushing the bottle body, this friction material is formulated with a designated Shore A durometer hardness.

In a preferred embodiment, the Shore A durometer hardness of the thermoplastic polyurethane lining the internal cavity 138 is within the range of approximately 60 A to 85 A, providing sufficient compliance to conform to minor surface irregularities of the bottle body while maintaining adequate rigidity to resist rotational slippage under the torque loads generated during cap removal. The selection of this durometer range is informed by the cooperative relationship between the grip handle 134 and the cap-turning wrench 110: because the wrench 110 applies a controlled, compliant gripping force calibrated to avoid cap damage, the torque transmitted through the bottle body to the internal cavity 138 remains within a predictable range, permitting optimization of the durometer hardness for grip performance without the need to accommodate unpredictable or excessive torque loads.

The structural components of the housing 112 and main body 134 may be constructed from rigid materials such as PLA or injection-molded plastic. Manufacturing of the apparatus may preferably utilize a two-shot injection molding process, allowing for the seamless integration of the rigid plastic body with overmolded softer materials on the grasping surface 140.

### V. Operation

In operation, the user inserts an eye drop bottle into the cavity 138 of the grip handle 134. The user then grasps the handle's external grasping surface 140, utilizing the secure fit within the cavity and the mechanical advantage of the ergonomic handle to immobilize the bottle body. Next, the user positions the wrench 110 over the bottle cap while the jaws 114 and 116 are in the open configuration.

The user presses the wrench onto the bottle, slightly deforming the compliance mechanism 118 by widening the distance between the two jaws due to the bottle cap's larger diameter. The compliance mechanism 118 subsequently exerts an inward compliant force, causing the textured inner surfaces 128 to tightly engage the cap. With the cap engaged and the bottle immobilized by the grip handle 134, the user applies a rotational force (torque) to the wrench housing 112. By preventing the bottle body from rotating relative to the user's hand, the grip handle 134 ensures that the force exerted by the wrench 110 is efficiently directed towards loosening and removing the cap.

1. An assistive apparatus for opening an eye drop bottle having a squeezable body and a cap, the apparatus comprising a two-component system configured to decouple rotational torque from bottle stabilization:
a bottle-stabilizing grip handle comprising a main body defining an internal cavity configured to receive the squeezable body and substantially conform to the squeezable body to immobilize the squeezable body, and an external grasping surface configured for a user's hand, wherein a wall defining the internal cavity further comprises an axially extending slot configured to allow radial flex of wall sections adjacent to the slot to maintain a continuous friction engagement against the squeezable body;
and a cap-turning wrench comprising a housing configured to be manipulated by a user, a jaw assembly operatively integrated with the housing, the jaw assembly comprising two opposing jaws defining a receiving area configured to encompass the cap, wherein the jaws are movable between an open configuration and a closed configuration, the jaws having cap-contacting inner surfaces, and a compliance mechanism biasing the jaws inward toward the closed configuration;
wherein the compliance mechanism comprises an arch structure connecting the two opposing jaws, the arch structure being configured to deform elastically under an insertion force and thereby exert a gripping force distributed across the cap-contacting inner surfaces of the jaws, and wherein the cap-contacting inner surfaces are tapered such that a distance between the cap-contacting inner surfaces is greater at a distal entry end than at a proximal base end relative to the housing, the taper creating a progressive wedging effect;
and wherein the continuous friction engagement provided by the axially extending slot is configured to resist rotation of the squeezable body while the wrench applies rotational torque to the cap, thereby preventing the squeezable body from spinning within the handle during operation.

2. The apparatus of claim 1, wherein the internal cavity of the grip handle is dimensioned to accommodate standard eye drop bottle volumes ranging from approximately 5 mL to 15 mL.

3. The apparatus of claim 1, wherein the cap-contacting inner surfaces of the jaws provide knurling to enhance grip.

4. The apparatus of claim 1, wherein the internal cavity of the grip handle employs a material comprising thermoplastic polyurethane having a Shore A durometer hardness of between 60 A and 85 A.

5. The apparatus of claim 1, wherein the internal cavity of the grip handle comprises a chamfer around an edge thereof, and the external grasping surface features finger indentations.

6. The apparatus of claim 1, wherein the taper of the cap-contacting inner surfaces of the jaws defines a draft angle of between approximately 0.5° and approximately 8° relative to a longitudinal axis of the wrench.

7. A cap-turning wrench for engaging a cap of an eye drop bottle, the wrench comprising:
a housing configured to be manipulated by a user;
a jaw assembly operatively integrated with the housing, the jaw assembly comprising two opposing jaws defining a receiving area adapted to encompass the exterior of the cap of the eye drop bottle, the receiving area being dimensioned to receive a cap of an eye drop bottle having a body volume between approximately 5 mL and approximately 15 mL; and
a compliance mechanism comprising an arch structure connecting the two opposing jaws, the arch structure being configured to deform elastically upon insertion of the cap into the receiving area and thereby exert a distributed inward gripping force against the cap, the distributed inward gripping force being calibrated to a force threshold sufficient to frictionally retain the cap against rotational torque required to overcome the cap's factory-seal thread resistance and insufficient to structurally deform the cap;
wherein inner surfaces of the jaws are both textured and tapered, a distance between the inner surfaces being greater at a distal entry end and lesser at a proximal base end such that the distance decreases progressively from the distal entry end toward the proximal base end.

8. The wrench of claim 7, wherein the taper defines a draft angle of between approximately 0.5° and approximately 8° relative to a longitudinal axis of the wrench.

9. The wrench of claim 8, wherein the draft angle is between approximately 0.5° and approximately 3°.

10. The wrench of claim 7, wherein each of the inner surfaces of the jaws defines a concave profile having a radius of curvature of between approximately 7 mm and approximately 10 mm in a transverse cross-section, the concave profile being shaped to conform to an outer surface of the cap.

11. The wrench of claim 7, wherein the arch structure defines an inner radius of between approximately 8 mm and approximately 12 mm in an unflexed state.

12. The wrench of claim 7, wherein a maximum overall length of the wrench measured along a longitudinal axis is between approximately 70 mm and approximately 90 mm, and a maximum overall width measured transverse to the longitudinal axis is between approximately 30 mm and approximately 45 mm.

13. A bottle-stabilizing grip handle for immobilizing a squeezable body of an eye drop bottle, the handle comprising:
a main body defining an internal cavity configured to receive the squeezable body, the internal cavity being shaped to conform to the squeezable body;
an external grasping surface on the main body, the external grasping surface being ergonomically contoured and having a larger grasping area than the squeezable body; and
an axially extending slot through a wall of the main body, the slot being configured to allow radial flex of wall sections of the wall adjacent to the slot;
wherein the slot serves as a dynamic tensioning element that maintains a friction-fit engagement with the squeezable body to prevent the squeezable body from rotating relative to the handle during application of external torque to the cap of the eye drop bottle.

14. The handle of claim 13, wherein the internal cavity is dimensioned to receive an eye drop bottle having a body volume between approximately 5 mL and approximately 15 mL.

15. The handle of claim 13, wherein the internal cavity comprises a lining of thermoplastic polyurethane having a Shore A durometer hardness of between 60 A and 85 A.

16. The handle of claim 13, wherein the internal cavity is dimensioned to receive an eye drop bottle having a body volume between approximately 5 mL and approximately 15 mL, wherein the internal cavity comprises a lining of thermoplastic polyurethane having a Shore A durometer hardness of between 60 A and 85 A, and wherein the internal cavity comprises a chamfer around an entry edge thereof.
